(19) United States
(12) Patent Application Publication
(10) Pub. No.: US 2019/0242166 A1
(43) Pub. Date: Aug. 8, 2019

(54) Hinge System

(71) Applicant: Dieter Ramsauer, Schwelm (DE)

(72) Inventor: Dieter Ramsauer, Schwelm (DE)

(21) Appl. No.: 16/309,615

(22) PCT Filed: Apr. 5, 2017
(86) PCT No.: PCT/EP2017/000415

§ 371 Date: Dec. 13, 2018

(30) Foreign Application Priority Data
Jun. 17, 2016 (DE) 20 2016 003 803.7

(51) Int. Cl. E05D 5/02; E05D 3/02; E05D 5/04

(52) U.S. Cl. CPC E05D 5/023; E05D 3/02; E05D 5/046; E05Y 2900/208; E05Y 2800/33; E05Y 2600/626; E05Y 2600/61; E05Y 2800/12; E05Y 2600/502

(57) ABSTRACT

A hinge system is described having at least one first hinge leaf with a single bore, suitable for fixing in an elongated opening or a row of openings in a thin wall, such as a door leaf or door frame of a metal cabinet or housing, wherein the first hinge leaf comes to lie against the margins of the breakthrough or the row of breakthroughs on one side of the thin and with a plate which comes to lie against the margins of the breakthrough or the breakthroughs on the other side of the thin wall, and with a screwed connection which presses together the two surfaces lying on the marginal surfaces, wherein, in the region of the breakthrough, projections extend from the hinge leaf or the plate which extend into or through the breakthroughs, wherein recesses are formed in the plate or the hinge leaf to receive the projections, wherein the projections are guided by the surfaces of the inner edges of the breakthroughs, wherein the threaded bore for the free end of screw passed through a projection provided with a bore.

The invention relates to a hinge system having at least one first hinge leaf with a single bore, suitable for fixing in an elongated opening or in several openings arranged in a row in a thin wall, such as a door leaf or door frame of a metal cabinet, wherein the hinge leaf comes to lie against the margins of the breakthrough or the breakthroughs on one side of the thin wall, and with a plate which comes to lie against the margins of the breakthrough or the breakthroughs on the other side of the thin wall, and with a screwed connection which presses together the two surfaces lying on the marginal surfaces, wherein, in the region of the breakthrough, projections extend from the hinge leaf or the plate which extend into or through the breakthroughs, wherein recesses are formed in the plate or the hinge leaf to receive the projections, wherein the projections are guided by the surfaces of the inner edges of the breakthroughs.

### PRIOR ART

Such a hinge system is already known from the brochure 4-247 Scharnier PrO1 180°, published by DIRAK GmbH, Königsfelder Str. 1, 58256 Ennepetal. Fixing by means of a screw has the advantage of simplifying installation, but requires a means of securing against rotation which is otherwise realised by means of a second fixing screw, as for example according to the brochure 4-271 Scharnier, justierbar PrO1 270°. In order to guarantee the fixing of the hinge leaves to the door leaf or the door frame, it is usual to provide the hinge with in each case two cast threaded pins, which is expensive.

### OBJECT OF THE INVENTION

It is the object of the invention to achieve the necessary security against rotation without the use of a second screw. At the same time, an adequate stability should be guaranteed, so that a single screw is sufficient to guarantee a secure and economical fixing, whether from inside or outside.

### SOLUTIONS TO THE OBJECT

The object of the invention is achieved in that the bore for the free end of the screw is passed through a projection.

The result of this is that the region of the bore for the screw is reinforced, so that greater stability is achieved, and moreover security against rotation is already achieved because the breakthrough is not round but elongated or consists of breakthroughs arranged in a row.

According to a further development of the invention, the hinge system possesses a second leaf which is connected with the first leaf by means of a hinge-pin arrangement and which also requires only one screw.

According to yet a further embodiment, the hinge system is characterised in that the bore for the head end of the screw is passed through the conical recess for a countersunk screw head.

The bore for the end of the screw can be formed in a tubular section which is reinforced through optional sloping partition walls.

The surfaces lying against the marginal surfaces can include grooves for O-ring seals, or the projection can include a screw thread for the screw.

The other projections can provide bridges between the two longitudinal edges of the breakthroughs.

The side surfaces of the projections can in turn form grooves for an O-ring seal.

In order to achieve axial adjustability it is favourable if the openings or the row of openings permit an axial displacement of the projections on the plate or the leaf projecting into them.

The hinge system can also be characterised in that the second hinge leaf is analogous or complementary in structure to the first hinge leaf.

It is also conceivable that one of the screws is arranged with its head on the inner side or the outer side of the door.

The projections or recesses arranged at the ends of the longitudinal extension of the rectangular breakthroughs can be arranged at a distance from the narrow rectangular edge for the purpose of axial adjustment (axially in the direction of the longer side of the rectangle or the row of breakthroughs).

In order to achieve axial and radial adjustability, one leaf can have a radial orientation of the rectangle and the other leaf an axial orientation.

### DESCRIPTION OF THE FIGURES

The invention is explained in more detail in the following with reference to exemplary embodiments which are represented in the drawings. wherein:

FIG. 1A shows a top view, from outside, of a
hinge according to the invention, according to a first embodiment, mounted on a cabinet, in a mounted perspective representation,

FIG. 1B shows a rear view of the hinge from FIG. 1A,

FIG. 1C shows a pulled-apart representation of the hinge according to FIG. 1A;

FIG. 2A shows another embodiment of the hinge according to the invention in a pulled-apart representation,

FIG. 2B shows the hinge from FIG. 2A in a sectional view illustrating the use of an O-ring seal,

FIG. 2C shows a similar embodiment with different arrangement of an O-ring seal,

FIG. 2D shows the unmounted hinge, opened up,

FIG. 2E shows a sectional view along the contact plane of one hinge part,

FIG. 2F shows an axial sectional view through one fixing possibility by means of a countersunk screw,

FIG. 2G shows a similar representation to FIG. 2F, but with inserted O-ring seal,

FIG. 2H shows a sectional view along the contact plane of the further embodiment,

FIG. 2I shows an axial sectional view illustrating the adjustability in an axial direction,

FIG. 2J shows the embodiment according to FIG. 2I, but with O-ring seal;

FIG. 3A shows a further embodiment of the hinge according to the invention in a pulled-apart representation,

FIG. 3B shows a sectional view along the contact surface of the leaf provided with projections;

FIG. 3C shows a representation of the opened unmounted hinge,

FIG. 3D shows a representation of the opened unmounted hinge,

FIG. 3E shows a corresponding representation of the other leaf;

FIG. 4A shows a further embodiment of the hinge according to the invention in a pulled-apart representation,

FIG. 4B shows a representation of the unmounted hinge in opened position,

FIG. 4C shows an axial representation of the section through one leaf,

FIG. 4D shows a corresponding representation through the other leaf; and

FIG. 5A shows an application of the hinge according to the invention with the possibility of adjustment in two dimensions.

### PARTICULARLY FAVOURABLE APPLICATIONS OF THE INVENTION

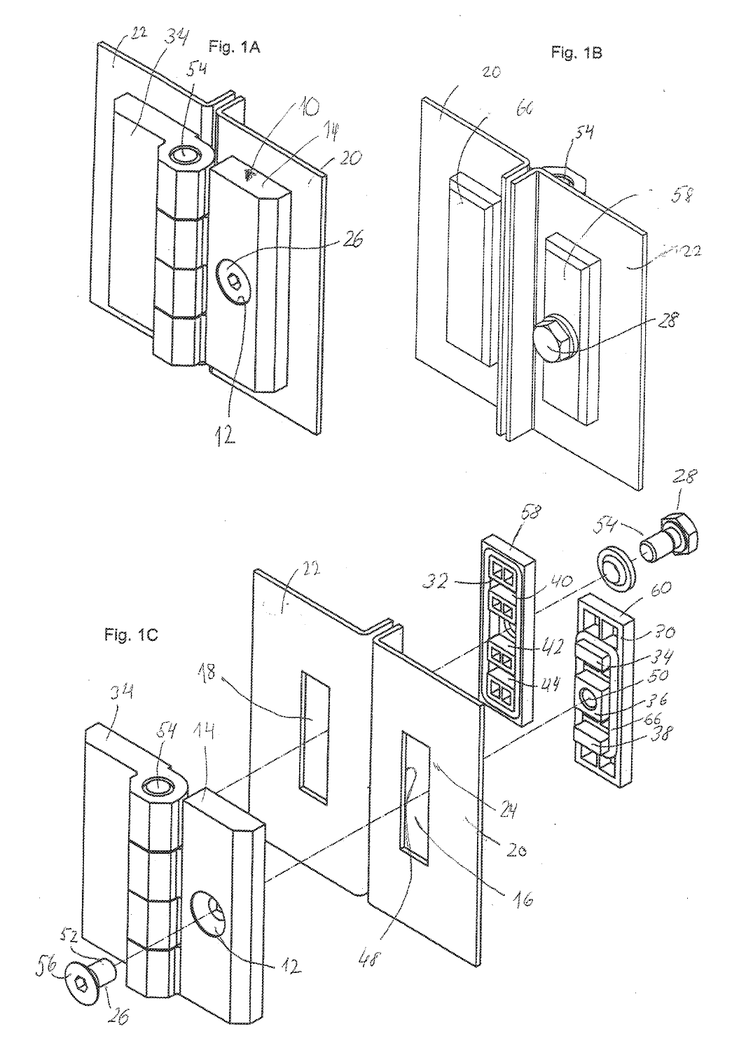

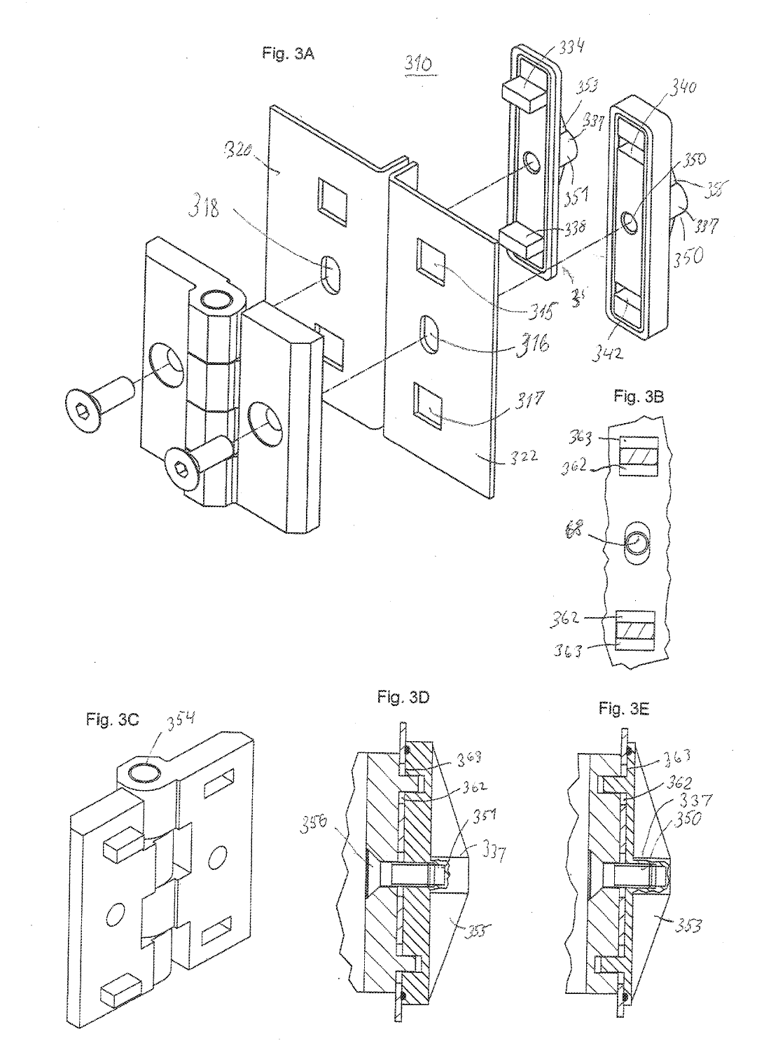

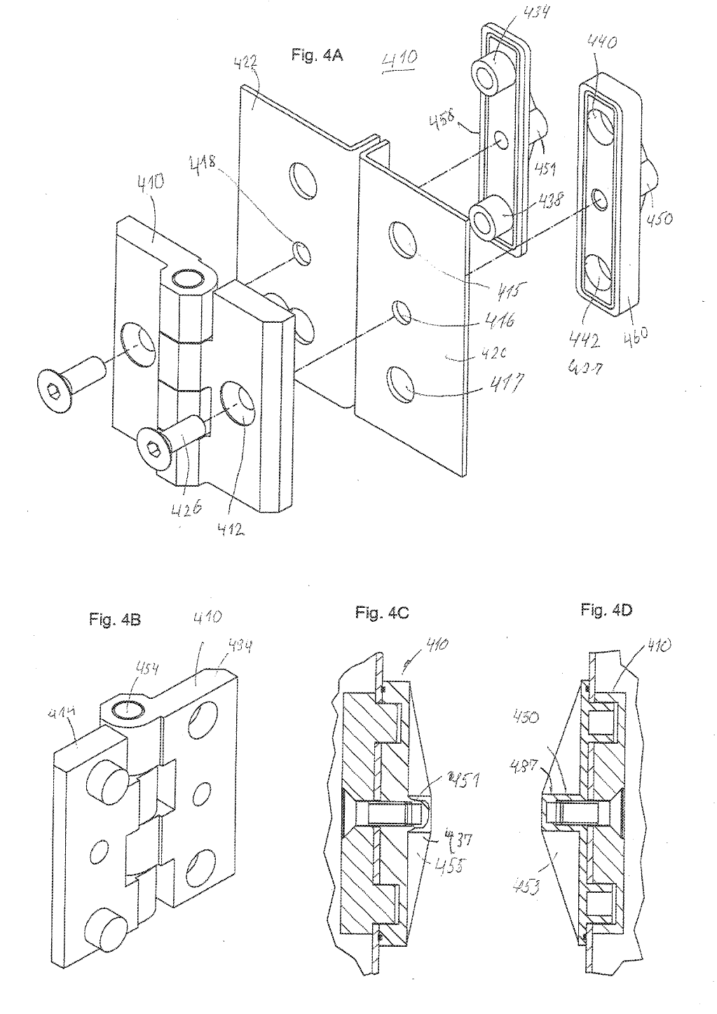

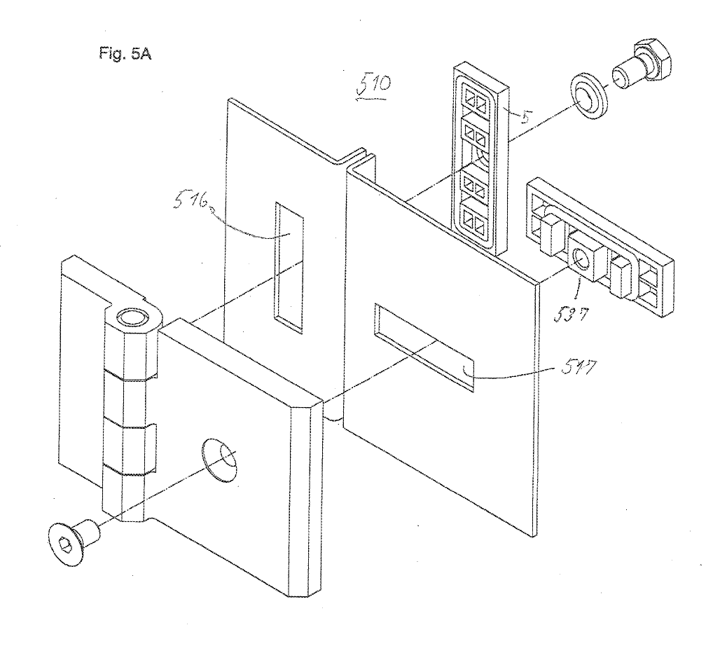

FIG. 1A shows a hinge system 10 viewed obliquely from the outside, consisting of a hinge leaf 14 with a bore 12, said hinge system being suitable for fixing in an elongated opening 16, see the pulled-apart representation of the hinge according to FIG. 1C, or alternatively in several openings arranged in a row, see reference numbers 316, 315, 317 in FIG. 3A, reference numbers 416, 415, 417 in FIG. 4A and reference numbers 517, 516 in FIG. 5A. The opening 16 in the thin wall 20 has marginal surfaces 24 against which the hinge leaves of the hinge 10 breakthrough come to lie. The two retaining surfaces 30, 32 lying against the marginal surfaces 24 are pressed together by means of a screwed connection 26 or 28, wherein projections 34, 36, 38 extend from the hinge leaves 14, 34 or the plate 30, 32 in the region of the breakthrough 16 or 18 which extend into or through the breakthroughs 16, wherein recesses 40, 42, 44 are formed in the plate or the hinge leaves 14, 32 to receive the projections 34, 36, 38, wherein the projections are guided by the surfaces 48 of the inner edges 48 of the breakthroughs 16, 18.

In particular and according to the invention, the bore 50 is passed through a projection 36 beyond the free end of the screw 26.

The embodiment shown in FIG. 1A to 1C also includes a second leaf 34 which is connected with the first leaf 14 in an articulated manner by means of a hinge pin 54.

The hinge system can be characterised in that the bore 12 for the head end 56 of the screw 26 is passed through the conical recess for a countersunk screw head.

The bore 50 provided with a thread 68 for the free end 26 of the screw can be formed in a tubular section 51, see FIG. 3E, which is reinforced through optional sloping partition walls 353, see FIG. 3A to 3E. The tubular section 353 or 350 thus contains a screw thread.

The projection 36 also contains a threaded bore 50.

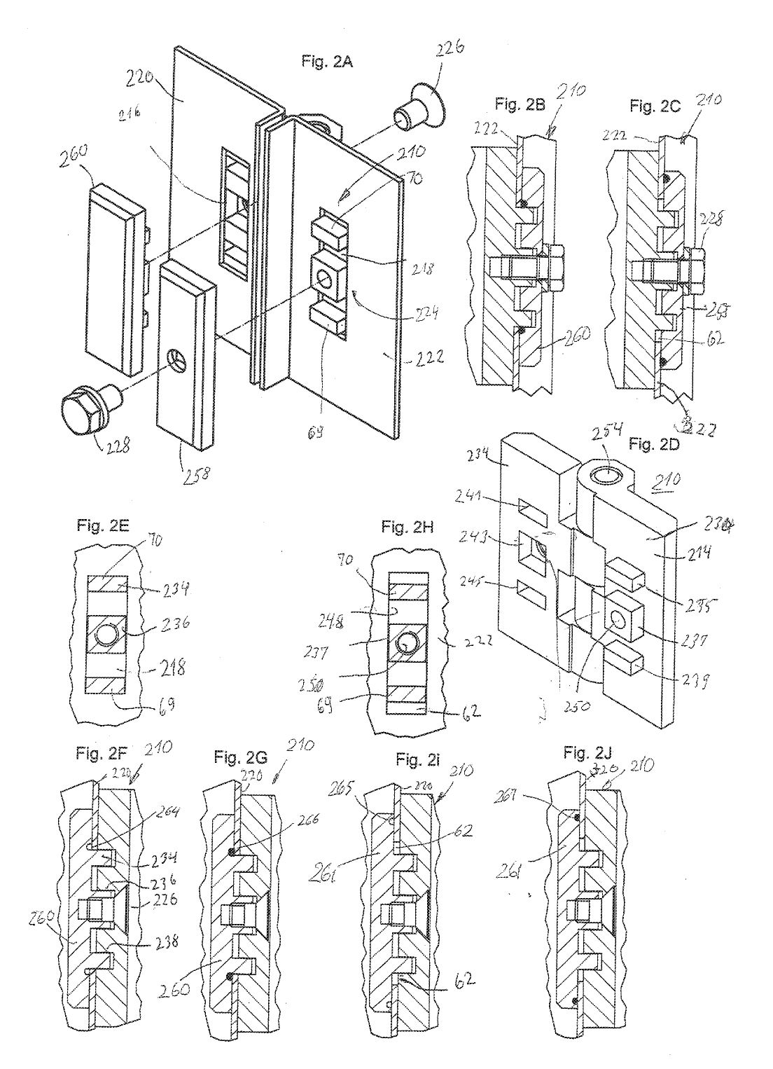

As can be seen from FIG. 1C as well as FIGS. 2E and 2H, and as can also be seen from FIG. 2A, the other projections, e.g. 234 in FIG. 2E, form bridges 69, 70 between the two longitudinal edges 248 of the breakthrough 218.

FIGS. 2E, 2F and 2G show that the side surfaces of the projections 69, 70, 276 also form grooves 264 for an O-ring seal 266.

In order to achieve axial adjustability, the rectangular breakthrough permit an axial displacement of the plate 260 and thus the projections on the plate relative to the hinge leaves, see reference numbers 62, 362.

The hinge system can be designed such that the second hinge leaf 34 is analogous or complementary in structure to the first hinge leaf 14.

FIGS. 1A, 1C and 2A for example show complementary hinge leaves 14, 34, 214, 334, whereas FIG. 3A for example shows an analogous arrangement.

FIG. 4A also shows a complementary arrangement in which, however, the arrangement of the screws 426 is analogous for the two leaves.

The further FIGS. 4C and 4D show, as a particularly favourable embodiment, that one screw 426 is arranged with its hexagonal screw head 428 on the outer side of the door, whereas FIG. 4B, 4C and FIG. 4D show a different arrangement.

It serves the purpose of axial adjustability if the projections 334, 338 or recesses 340, 342 arranged at the ends of the longitudinal extension of the rectangular breakthroughs are arranged at a distance 362 from the narrow rectangular edge.

In order to achieve axial and radial adjustability it is favourable if one leaf has a radial orientation of the longitudinal extension of the rectangular breakthrough and the other leaf has an axial orientation.

The projecting dog point of the fixing screw is square or rectangular in design and in the case of thicker metal doors penetrates into the bridge mounted at the back in order to provide security against rotation, even if the projecting outer extensions are shorter and do not reach the inner bridge.

### INDUSTRIAL APPLICATION

The invention can be applied commercially in the construction of switchgear cabinets.

### LIST OF REFERENCE NUMERALS

10, 110, 210, 310, 410, 510 Hinge system
12, 112, 212, 312, 412, 512 Bore
14, 114, 214, 414, 514 Hinge leaf (first with through-bore)
315 Opening
16, 216, 316, 416, 516 Opening
517 Opening
18, 218, 318, 418, 518 Opening
20, 220, 320, 420 Thin wall, door leaf
22, 222, 322, 422 Thin wall, door frame
24, 224 Marginal surface
26, 226, 426 Screwed connection, end of screw, screw
28, 228, 428 Screwed connection
30 Retaining surface
32 Retaining surface
34, 234, 434 Hinge leaf (second) (with threaded bore)
235 Projection
36, 236 Projection
237, 337, 437, 537 Projection
38, 438 Projection
239 Projection
40, 440 Projection
241 Recess
42, 442 Recess
243 Recess
44 Recess
245 Recess
46 Recess
48, 248 Inside edge of opening, edges
50, 250 Bore
51, 451 Tubular section
52 Free end
353 Partition wall
54, 254, 454 Hinge pin
355, 455 Partition wall
56 Head end
58, 258, 458 Retaining plate (with through-bore)
60, 260, 460 Retaining plate (with threaded bore)
261 Retaining plate
62, 362 Breakthrough extension, play
63,363 Breakthrough extension, play
264 Groove
265 Groove
66, 266 O-ring seal
267 O-ring seal
68 Thread
69 Bridge
70 Bridge

1.-15. (canceled)

16. A hinge system having at least one first hinge leaf with a single bore, configured for fixing in an elongated breakthrough or a row of breakthroughs in a thin wall, such as a door leaf or a door frame of a metal cabinet or a housing, wherein the at least one first hinge leaf comes to lie against margins of the breakthrough or the row of breakthroughs on one side of the thin wall, and with a plate which comes to lie against margins of the breakthrough or the breakthroughs on the other side of the thin wall, and with a screwed connection which presses together two surfaces lying on marginal surfaces, wherein, in a region of the breakthrough, first projections extend from the at least one first hinge leaf or the plate which extend into or through the breakthroughs, wherein recesses are formed in the plate or the hinge leaf to receive the first projections, wherein the first projections are guided by surfaces of inner edges of the breakthroughs, wherein a threaded bore for a free end of a screw is passed through a second projection provided with a bore, wherein the hinge comprises a second leaf which is connected pivotably with the first leaf by means of a hinge pin,
wherein the bore for a head end of the screw is passed through a conus of a recess for a conical countersunk screw head,
wherein the bore is a threaded bore for the free end of the screw, which is formed in a tubular section which is reinforced through optional sloping partition walls, and
wherein the second projection for the screw includes a screw thread.

17. The hinge system according to claim 16, wherein the surfaces lying on the marginal surfaces represent grooves for ring seals.

18. The hinge system according to claim 16, wherein the projections form a plurality of bridges between two longitudinal edges of the breakthrough.

19. The hinge system according to claim 16, wherein side surfaces of second projections form grooves for a O-ring seal.

20. The hinge system according to claim 16, wherein, in order to achieve axial adjustability, openings permit an axial displacement of the projections on the plate or an axial displacement of leaves projecting into or through the openings.

21. The hinge system according to claim 16, wherein the plate comprises recesses configured to displace the plate in an axial direction.

22. The hinge system according to claim 16, wherein the second hinge leaf is analogous or complementary in structure to the first hinge leaf.

23. The hinge system according to claim 16, wherein one of the screws is arranged with its head on an inner side or an outer side of the door.

24. The hinge system according to claim 16, wherein the projections or recesses arranged at the ends of a longitudinal extension of the rectangular breakthroughs are arranged at a distance from a narrow rectangular edge in order to permit axial adjustment in the direction of a longer side of the narrow rectangular edge or the row of breakthroughs.

25. The hinge system according to claim 16, wherein, in order to achieve axial and radial adjustability, one leaf has a radial orientation of the narrow rectangular edge and the other leaf has an axial orientation.

26. The hinge system according to claim 16, wherein a projecting thread attachment of the fixing screw is square or rectangular in design and, in the case of thicker door plates, penetrates into the bridge mounted at the back in order to provide security against rotation.
